(19) United States
(12) Patent Application Publication
(10) Pub. No.: US 2013/0186985 A1
(43) Pub. Date: Jul. 25, 2013

(54) UNIT FUEL INJECTOR HAVING CHECK VALVE BODY AND SPRING CAGE FORMING A REVERSE FLOW CHECK CAVITY

(71) Applicant: Erik Jordan Hansen, Ann Arbor, MI (US)

(72) Inventor: Erik Jordan Hansen, Ann Arbor, MI (US)

(73) Assignee: International Engine Intellectual Property Company , LLC, Lisle, IL (US)

(21) Appl. No.: 13/822,707

(22) PCT Filed: Sep. 13, 2010
(86) PCT No.: PCT/US2010/048569

§ 371 Date: Mar. 13, 2013

(51) Int. Cl. F02M 61/04

(52) U.S. Cl. CPC F02M 61/04
USPC 239/562

(57) ABSTRACT

A proximal end face of a proximal end wall (82) of a spring cage (42) in a unit fuel injector (30) and a distal end face of a check valve body (44) cooperatively define a reverse flow check cavity (124) within which a reverse flow check (122) is disposed for selectively opening and substantially closing an exit through-passage (112) in the check valve body (44). The reverse flow check opens the exit through-passage during high-pressure injection and substantially closes the exit through-passage when injection ceases.

### TECHNICAL FIELD

This disclosure relates generally to internal combustion engines having cylinders into which fuel is injected, and more particularly to a unit injector for direct high-pressure injection of diesel fuel into an engine cylinder.

### BACKGROUND OF THE DISCLOSURE

A known electronic engine control system comprises a processor-based engine controller that processes data from various sources to develop control data for controlling certain functions of the engine, including fueling of the engine by unit fuel injectors that inject fuel directly into engine cylinders. One type of unit fuel injector is commonly known as a HEUI injector, the four-letter acronym standing for hydraulically-actuated, electrically-controlled unit injector.

A HEUI injector has a fuel inlet port communicated to a source of fuel under pressure, such as pressurized fuel in a fuel rail. It also has an oil inlet port communicated to a source of hydraulic fluid under pressure, such as pressurized oil in an oil rail. Fuel is injected out of the injector through orifices in a nozzle having a tip end disposed within the head end of an engine cylinder.

Injection of fuel is controlled by an electric actuator that when actuated opens a valve that allows oil from the oil rail to pass through the oil inlet port and apply hydraulic force to a piston that is disposed at one end of a plunger. The piston transmits the hydraulic force to the plunger which then applies the force to fuel that the pressure in the fuel rail has forced into the fuel injector. The hydraulic force creates additional and much greater pressure (intensified pressure) that acts on certain movable elements within the fuel injector.

One such movable element is an entry check that is disposed in an entry through-passage for allowing fuel to flow from the fuel inlet port through the entry through-passage for replenishing the injector when the actuator is not actuated, but that is forced to close the entry through-passage when the actuator is actuated for trapping fuel that has replenished the injector so that the fuel does not backflow through the fuel inlet port but rather is forced through a high-pressure injection passage to, and out of, the nozzle orifices as the hydraulic force is causing the plunger to extend.

Another movable element is a reverse flow check that is disposed in an exit through-passage leading to the high-pressure injection passage for substantially closing the exit through-passage to the high-pressure injection passage when a return spring forces the piston to retract upon the actuator ceasing to be actuated. The reverse flow check avoids the creation of a sudden large pressure drop in the high-pressure injection passage that could otherwise occur as the retracting plunger is creating low pressure that opens the entry check and draws replenishment fuel into the injector.

With the injector having been replenished, the next actuation of the actuator causes the plunger to once again increase pressure on fuel and force the entry check closed to prevent backflow of fuel out of the injector through the inlet port, while forcing the reverse flow check to open. The intensified fuel pressure acts along the high-pressure injection passage to unseat a spring-biased needle from an internal seat in the nozzle. The unseating of the needle against the opposing spring bias opens the high-pressure injection passage to the nozzle orifices to allow fuel to be injected into an engine cylinder as the plunger extends. When the actuator ceases being actuated, the intensified pressure that was being applied by the plunger terminates, allowing the bias spring to re-seat the needle and thereby terminate injection.

Control of injection encompasses control of both the duration of an injection of fuel and the timing of the injection so that the control system thereby controls quantity of fuel injection and when fuel is injected during an engine cycle.

### SUMMARY OF THE DISCLOSURE

The ability of a unit fuel injector to inject fuel at increasingly higher pressures can have favorable implications for quality of combustion and engine performance. Higher pressures however create larger stresses in component parts, and those stresses are amplified even more at stress concentration points. The cyclical nature of such stresses and the sheer number of injection cycles that a fuel injector will typically perform may eventually tax component parts, even those made of extremely strong materials, to failure at stress concentration points. Because increased pressure also increases forces that act to separate component parts, internal leakage is more apt to occur.

The present disclosure relates to a unit fuel injector that can operate at high injection pressures consistent with design intent throughout the injector's expected useful life.

Briefly, the disclosed unit fuel injector comprises several internal parts one of which is a spring cage having a proximal end wall and a cylindrical sidewall that extends distally from an outer margin of the proximal end wall to form an interior for housing a needle bias spring that biases a needle toward seating on a seat in a nozzle containing orifices through which fuel is injected when the needle is unseated. A portion of a high-pressure injection path through which fuel is forced by a plunger during injection extends through both the proximal end wall and the cylindrical sidewall of the spring cage. A reverse flow check cavity for a reverse flow check is present between the proximal end face of the proximal end wall of the spring cage and a distal end face of a check valve body (another of the internal parts) that is forcibly held against the proximal end face of the spring cage.

This disclosure includes various embodiments of spring cage and check valve body.

As generally claimed, the presently disclosed device relates to a unit fuel injector comprising a main body circumferentially surrounding an imaginary longitudinal axis and an interior that is open both at a distal end and at a proximal end. Fuel can enter the interior of the main body through a fuel inlet port. A check valve body is disposed within the interior of the main body and has a proximal end face and a distal end face.

An intensifier cartridge comprises a cartridge body that closes the open proximal end of the main body, that has a distal end face disposed within the interior of the main body against the proximal end face of the check valve body, and that has a bore extending proximally from a bore entrance at its distal end face.

A spring cage comprises an interior proximally bounded by a proximal end wall having a proximal end face and circumferentially bounded by a cylindrical sidewall. The proximal end face of the proximal end wall is disposed against the distal end face of the check valve body. The sidewall of the spring cage extends distally from the proximal end wall of the spring cage to a distal end at which the interior of the spring cage is open.

A nozzle closes the open distal end of the main body and comprises a proximal end face disposed within the interior of the main body against the distal end of the spring cage sidewall. The nozzle further comprises a needle guide bore comprising a proximal portion extending distally from the nozzle's proximal end face to a needle feed cavity and a distal portion extending distally from the needle feed cavity.

A bias spring is housed within the interior of the spring cage. A needle is guided for axial displacement by the needle guide bore and is biased by the bias spring against a seat in the distal portion of the needle guide bore to close a high-pressure injection path to orifices through which fuel is injected from the nozzle when the needle is unseated from the seat.

The check valve body comprises an entry through-passage open to the fuel inlet port and containing an entry check for opening and closing the entry through-passage to the bore entrance of the cartridge body.

The spring cage and the check valve body cooperatively define a reverse flow check cavity between the proximal end face of the proximal end wall of the spring cage and the distal end face of the check valve body.

The check valve body comprises an exit through-passage for communicating the bore entrance of the cartridge body to the reverse flow check cavity. A reverse flow check is disposed in the reverse flow check cavity.

The spring cage comprises an adjoining cavity distally adjoining the reverse flow check cavity via a ledge on which the reverse flow check can seat and a passage extending from the adjoining cavity to the distal end of the spring cage sidewall.

The nozzle comprises a passage extending from the nozzle's proximal end face to the needle feed cavity for communicating the passage in the spring cage to the needle feed cavity.

The intensifier cartridge comprises a plunger that is displaceable within the cartridge body bore along the longitudinal axis, and when displaced axially proximally, is effective to unseat the entry check and allow fuel to pass through the fuel inlet port into the interior of the fuel injector, through the entry through-passage and bore entrance into the cartridge body bore while forcing the reverse flow check to substantially close the exit through-passage. When displaced axially distally, the plunger is effective to force the entry check to close the entry through-passage and force the reverse flow check out of substantial closure of the exit through-passage and to seat on the ledge, and to force fuel out of the cartridge body bore through the bore entrance and through the high-pressure injection path comprising the exit through-passage, the reverse flow check cavity, clearance between the reverse flow check and the ledge, the adjoining cavity, the passage in the spring cage, the passage in the nozzle, and the distal portion of the needle guide bore to cause the needle to unseat and fuel to be injected out of the nozzle through the orifices.

As generally claimed, the presently disclosed device also relates to a unit injector having a longitudinal axis and comprising a nozzle having orifices through which fuel is injected from the nozzle, a spring cage having an interior proximally bounded by a proximal end wall having a proximal end face and circumferentially bounded by a cylindrical sidewall that extends distally from the proximal end wall to a distal end at which the interior of the spring cage is open, a bias spring disposed within the spring cage interior and biasing a needle to seat on a seat in the nozzle, and a plunger operable on fuel in the injector to force open a reverse flow check disposed in a reverse flow check cavity in a high-pressure injection path from the plunger to the needle to unseat the needle from the seat against seating force imposed on the needle by the bias spring and to force fuel through the high-pressure injection path and out of the orifices. The proximal end face of the proximal end wall of the spring cage comprises an adjoining cavity distally adjoining the reverse flow check cavity via a ledge on which the reverse flow check seats when forced open, and the high-pressure injection path comprises a passage extending from the adjoining cavity to the distal end of the spring cage sidewall.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is an elevation view of a fuel injector partly in cross section.

FIG. 2 is an enlarged perspective view of a reverse check, by itself, in the fuel injector of FIG. 1.

FIG. 3 is an enlarged cross section view of certain parts of the fuel injector of FIG. 1 looking in the same direction as the view of FIG. 1.

FIG. 4 is a view similar to FIG. 3 showing another embodiment.

FIG. 5 is a view similar to FIG. 3 showing still another embodiment.

FIG. 6 is a view similar to FIG. 3 showing still another embodiment.

FIG. 7 is a view similar to FIG. 3 showing still another embodiment.

FIG. 8 is a view showing a further embodiment.

FIG. 9 is a view showing a further embodiment.

FIG. 10 is a view showing a further embodiment.

FIG. 11 is a view showing a further embodiment.

FIG. 12 is a view showing a further embodiment.

### DETAILED DESCRIPTION

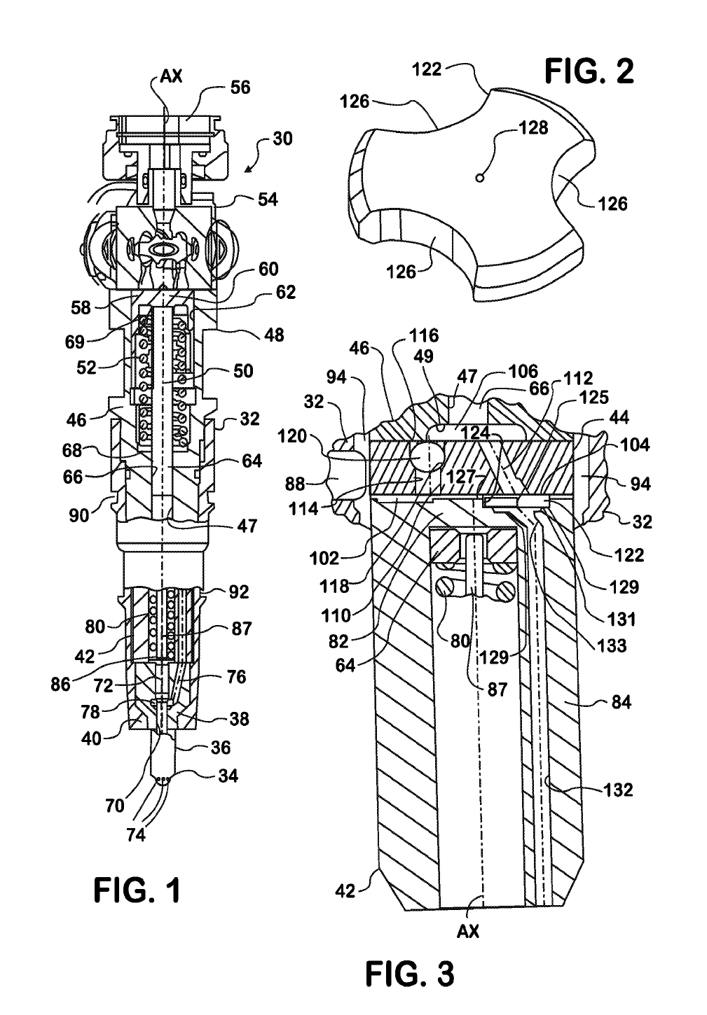

FIG. 1 shows a fuel injector 30 comprising a generally cylindrical main body 32 that mounts on a cylinder head of an engine (not shown) to dispose a tip end 34 of a nozzle 36 in the head end of a cylinder bore (not shown) within which a piston coupled by a piston rod to a crankshaft reciprocates. Fuel injector 30 is intended for use with a diesel engine to inject diesel fuel directly into the cylinder where the fuel combusts in air that has been compressed by the piston to create pressure that forces the piston to downstroke and impart torque to the crankshaft through the piston rod.

Main body 32 has an imaginary longitudinal axis AX and an interior that is open at both a proximal end of axis AX and a distal end of axis AX. A larger diameter portion of nozzle 36 is disposed within the interior of main body 32 to close the main body's open distal end by abutment of an outer shoulder 38 of nozzle 36 with an inner shoulder 40 of main body 32 while a smaller diameter portion of nozzle 36 that includes tip end 34 protrudes distally out of main body 32. The larger diameter portion of nozzle 36 comprises a flat proximal end face against which an annular distal end face of a spring cage 42 is disposed.

An intensifier cartridge 48 closes the open proximal end of main body 32 and comprises a generally cylindrical cartridge body 46 having a distal end face that as shown in FIG. 3 is disposed within the interior of main body 32 against a proximal end face of a check valve body 44. Cartridge body 46 comprises a bore 47 that is coaxial with axis AX and open to an entrance cavity 49 at its distal end. Intensifier cartridge 48 further comprises a piston 58, a plunger 50, and a return spring 52 that acts to bias plunger 50 and piston 58 proximally of axis AX.

Mounted at a proximal end of cartridge body 46 is an electric-actuated valve 54 that has an outlet port open to a proximal end face of piston 58 and an inlet port 56 that is communicated to oil under pressure in an oil rail (not shown) when fuel injector 30 is installed on an engine.

Piston 58 comprises a circular head 60 that contains the piston's proximal end face to which the outlet port of valve 54 is open. Piston 58 also has a skirt extending distally from head 60 and providing a close sliding fit for the piston within a larger diameter circular bore portion 62 of bore 47 that is open to the proximal end of cartridge body 46.

Plunger 50 has a smaller diameter than piston 58 and extends distally from the interior of head 60 to have a close sliding fit within a smaller diameter circular bore portion 66 of bore 47.

A shoulder 68 at the junction of larger diameter circular bore portion 62 and smaller diameter circular bore portion 66 provides support for a bearing at the distal end of return spring 52. The proximal end of return spring 52 bears against a head 69 of plunger 50 that in turn bears against piston head 60 without plunger head 69 attaching to piston head 60.

Nozzle 36 comprises a central needle guide bore 70 that is concentric with axis AX and open at the nozzle's flat proximal end face and that extends distally to tip end 34. A needle 72 is disposed within needle guide bore 70 and guided for displacement along axis AX.

Within the interior of tip end 34, needle guide bore 70 has a tapering surface (obstructed from view in FIG. 1) providing a seat for a tapering end of needle 72. The seat is a proximal boundary for a SAC volume circumferentially around which a series of orifices 74 extend through the nozzle wall to the nozzle exterior.

Spring cage 42 is a part that comprises a proximal end wall 82 (see FIG. 3) and a circular cylindrical sidewall 84 extending distally to bound an interior that is open at the distal end of the spring cage. A coiled bias spring 80 is disposed within the interior of spring cage 42 for biasing needle 72 to seat on the seat. A proximal end of bias spring 80 bears against an annular shim 64 (see FIG. 3) that in turn bears against proximal end wall 82 while a distal end of spring 80 bears against a disk 86 (FIG. 1) that in turn bears against a proximal end face of needle 72. The proximal end of a needle lift pin 87 passes with clearance through the open center of shim 64. Needle lift pin 87 has a length that is less than the axial distance between end wall 82 and the proximal end face of needle 72 when the needle is seated for limiting proximal displacement (i.e. lift) of needle 72 off the seat.

Nozzle 36 comprises a slant passage 76 through which fuel enters the nozzle. Slant passage 76 has a circular cross-section about an axis that extends in a straight line to intersect a needle feed cavity 78 that is located between proximal and distal portions of needle guide bore 70. Axially between needle feed cavity 78 and the needle seat, radial clearance between needle 72 and needle guide bore 70 allows fuel flow from needle feed cavity 78 along the needle's length to the needle seat.

Check valve body 44 has a circular shape that fits within the interior of main body 32 concentric with axis AX. FIG. 3 shows a distal end face of check valve body 44 disposed against a proximal end face of proximal end wall 82.

Fuel injector 30 is one of several like it that are mounted in an engine cylinder head. Fuel under pressure in a fuel supply system (not shown) serving all fuel injectors can enter main body 32 through one or more holes 88 (see FIG. 3) that form a fuel inlet port of injector 30. Hole 88 is located axially between a proximal circular groove 90 and a distal circular groove 92 (see FIG. 1) that extend around the outside of main body 32 and that contain O-ring seals (not shown) for sealing an exterior zone of main body 32 that is exposed to fuel in the fuel supply system.

FIG. 3 shows hole 88 open to a fuel space 94 between an inside surface of main body 32 and outside surfaces of spring cage 42, check valve body 44, and cartridge body 46.

With nozzle 36, spring cage 42, and check valve body 44 stacked axially within the interior of main body 32, cartridge body 46 is tightly fastened and sealed to main body 32, causing shoulders 38 and 40 to forcefully abut each other, the distal end face of check valve body 44 to forcefully abut the proximal end face of proximal end wall 82 of spring cage 42, and the distal end face of cartridge body 46 to forcefully abut the proximal end face of check valve body 44. The force is large enough to seal each of the three joints created by these abutments.

At the joint between proximal end wall 82 and check valve body 44, formations bound an entry cavity 102 that is open to fuel space 94 and an exit cavity 104 not open to fuel space 94. At the joint between cartridge body 46 and check valve body 44, entrance cavity 49 bounds a zone 106 to which the distal end of smaller diameter bore portion 66 is open.

One or more dowels (not shown) provide proper circumferential location of spring cage 42, check valve body 44, and cartridge body 46 to one another while one or more other dowels (also not shown) assure coaxiality of nozzle 36 to axis AX and provide proper circumferential location of spring cage 42 to nozzle 36.

An entry through-passage 110 extends through check valve body 44 parallel to axis AX and comprises a smaller diameter circular portion 114 joining with a larger diameter circular portion 116 via a tapered portion 118. An exit through-passage 112 extends through check valve body 44 non-parallel to axis AX.

Smaller diameter circular portion 114 is open at its distal end to entry cavity 102. Larger diameter circular portion 116 is open to bore 47 through zone 106. The proximal end of exit through-passage 112 is in communication with the open distal end of cartridge body bore 47 through zone 106 and the distal end of exit through-passage 112 is open at the distal end face of check valve body 44.

An entry check in the form of a sphere, or ball, 120 is disposed in larger diameter circular portion 116 of entry through-passage 110 and has a diameter smaller than that of larger diameter circular portion 116. Ball 120 can seat on and unseat from tapered portion 118 to close and open entry through-passage 110.

A circular reverse flow check cavity 124 distally adjoins exit cavity 104 via a ledge 127 that is a surface portion of the proximal end face of proximal end wall 82 of spring cage 42. A reverse flow check 122, shown by itself in FIG. 2, is disposed in reverse flow check cavity 124 and shown in FIG. 3 resting on a ledge 129. A circular adjoining cavity 131 of smaller diameter than reverse flow check cavity 124 adjoins cavity 124 by extending distally from ledge 129. Cavities 124 and 131 have a central axis 125 parallel to and spaced radially from axis AX. Exit through-passage 112 opens to exit cavity 104 and reverse flow check cavity 124 substantially at axis 125.

Reverse flow check 122 has flat proximal and distal end faces and would have a full circular shape except for three concave reliefs 126 symmetrically arranged in its outer margin. The proximal end face of reverse flow check 122 can seat against the flat end surface portion of check valve body 44 surrounding the distal end of exit through-passage 112 (i.e. against the margin of exit through-passage 112) to substantially close exit through-passage 112 while a central through-hole 128 in reverse flow check 122 provides a flow restriction through reverse flow check 122 whose purpose will be explained later.

When reverse flow check 122 unseats from the margin of exit through-passage 112 to seat on ledge 129, fuel flows through exit through-passage 112 and into exit cavity 104. Fuel flow that has passed through exit cavity 104 passes through reverse flow check cavity 124 and through clearance between the perimeter of reverse flow check 122 and ledge 129 provided by portions of reliefs 126 that are radially inward of the inner edge of the ledge. The fuel flow then passes into and through adjoining cavity 131.

From cavity 131 flow continues through a short straight slant passage 133 of circular cross section extending non-parallel to axis AX and then through a straight passage 132 also of circular cross section extending axially through sidewall 84 parallel to axis AX to the annular distal end face of spring cage 42 where it registers with the open proximal end of slant passage 76 in nozzle 36.

With structural detail of fuel injector 30 having been described, its operation can now be explained.

With valve 54 closed and fuel injector 30 having been fully charged with relatively lower pressure fuel from the relatively lower pressure fuel supply system, plunger 50 and piston 58 assume a maximally retracted, initial position as shown in FIG. 1. Fuel that has entered through hole 88 in main body 32 fills fuel space 94, entry cavity 102, entry through-passage 110, zone 106, and the portion of bore 47 distal to plunger 50. Reverse flow check 122 may or may not be seated against the margin of exit through-passage 112 depending on difference between pressure in passages 132, 133 and pressure in exit through-passage 112.

When valve 54 is actuated open, oil passes through to apply hydraulic force to piston 58, initiating distal movement of plunger 50 that begins forcing fuel out of cartridge body bore 47. Because needle 72 is seated closed on its seat in nozzle 36, the fuel from bore 47 flows toward entry through-passage 110, forcing ball 120 to seat on tapered portion 118 thereby closing entry through-passage 110 so that fuel does not backflow out of fuel injector 30. With the fuel now being essentially trapped, the hydraulic force of the oil, amplified by the ratio of the larger area of the proximal end face of piston 58 to the smaller area of the distal end face of plunger 50, greatly increases the fuel pressure in zone 106.

If reverse flow check 122 is not already unseated from the margin of exit through-passage 112, the increased fuel pressure forces reverse flow check 122 to unseat from that margin and seat on ledge 129 so that the increased fuel pressure is felt along a high-pressure injection path extending from zone 106, through exit through-passage 112, exit cavity 104, reverse flow check cavity 124, adjoining cavity 131, passages 133, 132, 76, to needle feed cavity 78 and needle 72. Because of the needle geometry, the pressure acts on needle 72 with a proximally directed force component that overcomes the distally directed force of bias spring 80, resulting in unseating of needle 72 and accompanying proximal displacement of disk 86. Continued displacement of plunger 50 forces fuel out of bore 47 through zone 106, exit through-passage 112, past reverse flow check 122, through passage 133, through passage 132, through slant passage 76, through needle guide bore 70, and finally out of nozzle 36 through orifices 74. Shim 64 sets the bias force that spring 80 exerts on needle 72 and hence fuel pressure acting on the needle that must be exceeded in order for the needle to unseat.

Injection continues as long as plunger 50 continues to move distally. When valve 54 closes during an on-going injection, further distal movement of plunger 50 and piston 58 ceases. Fuel pressure quickly drops in zone 106, and return spring 52 acts to return plunger 50 and piston 58 proximally toward initial position.

The fuel pressure drop in zone 106 creates a pressure differential that forces reverse flow check 122 to seat on the margin of exit through-passage 112 so that some elevated pressure in the high-pressure injection path is maintained as needle 72 re-seats in order to oppose entry of products of combustion in the engine cylinder through nozzle orifices 74 before needle 72 has re-seated. Through-hole 128 provides a restriction that, while reverse flow check 122 is held in substantial closure of exit through-passage 112, allows the intensified pressure trapped in the high-pressure injection path to decay slowly once needle 72 has re-seated.

The sudden pressure drop in zone 106 also allows the fuel supply pressure to unseat ball 120 so that fuel from the fuel supply system can replenish the injector by flow through entry through-passage 110 and zone 106 and into bore 47 as plunger 50 and piston 58 are retracting.

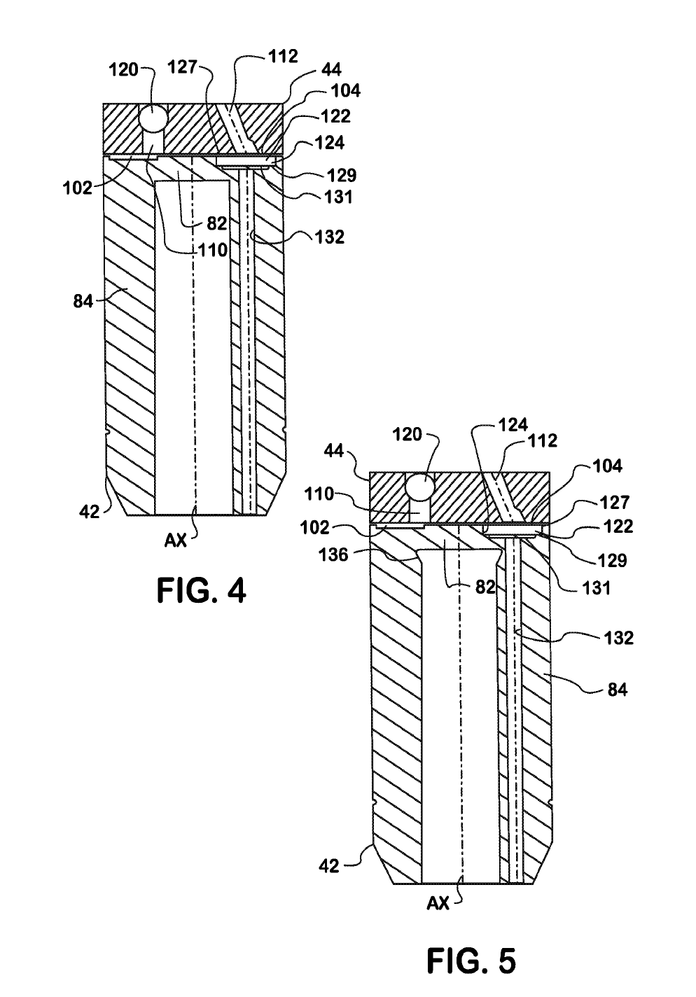

FIG. 4 shows an embodiment that is like the one of FIGS. 1-3 except that exit through-passage 112 and reverse flow check cavity 124 are somewhat farther from axis AX so that the passage 132 to the distal end of spring cage 42 is straight and parallel to axis AX from adjoining cavity 131.

FIG. 5 shows an embodiment that is like the one of FIG. 4 except that at the proximal end of the interior of spring cage 42, there is a rounded undercut 136 for blending the interior surface of sidewall 84 and the interior surface of proximal end wall 82. Undercut 136 extends radially outwardly from the interior surface of sidewall 84 before blending with the interior surface of proximal end wall 82.

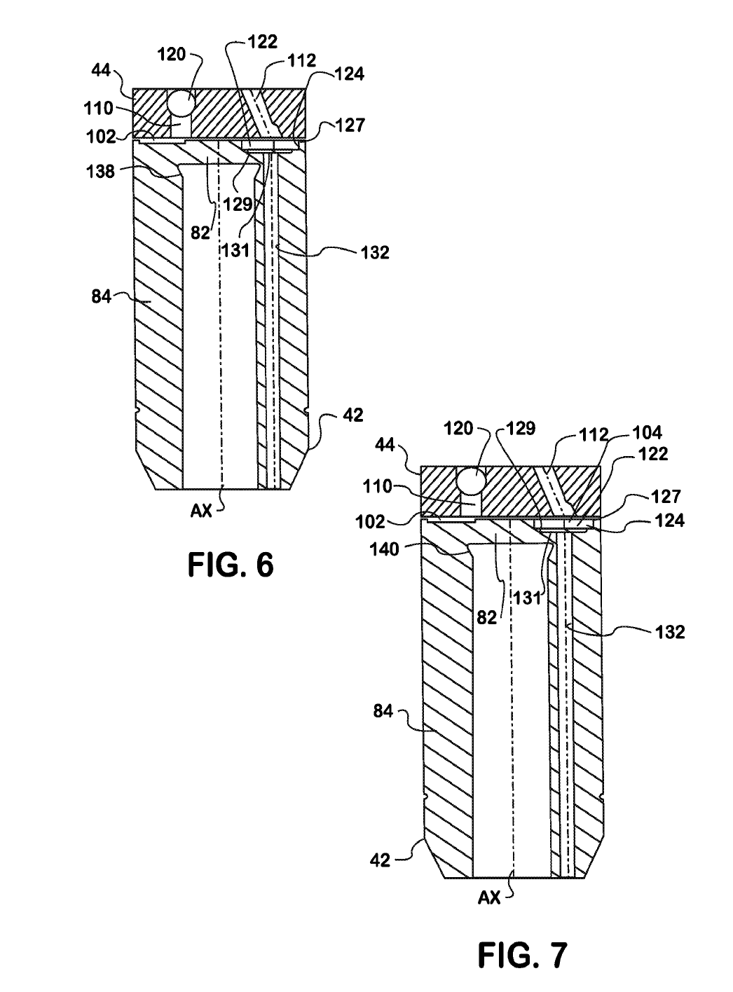

FIG. 6 shows an embodiment that is like the one of FIG. 5 except that a rounded undercut 138 at the proximal end of the interior of spring cage 42 extends axially proximally of the interior surface of sidewall 84 beyond the interior surface of proximal end wall 82 before blending with the latter surface.

FIG. 7 shows an embodiment that is like the one of FIGS. 5 and 6 except that a rounded undercut 140 at the proximal end of the interior of spring cage 42 extends radially outwardly from the interior surface of sidewall 84 and then axially proximally beyond the interior surface of proximal end wall 82 before blending with the latter surface.

FIG. 8 shows a further embodiment of check valve body 44 and spring cage 42 in which a circular reverse flow check cavity 124 for reverse flow check 122 is formed in the distal end face of check valve body 44 and a circular adjoining cavity 131 coaxial with, and of small diameter than, cavity 124 is formed in the proximal end face of proximal end wall 82 of spring cage 42. Exit through-passage 112 opens to cavity 124 at the center of the cavity, with the exit through-passage axis being non-parallel with axis AX. The diameter of reverse flow check 122 is slightly smaller than that of cavity 124 so that when the proximal face of reverse flow check 122 seats on the margin of exit through-passage 112 as needle 72 re-seats, flow can occur only through through-hole 128 to maintain some elevated pressure in the high-pressure injection path as that pressure decays. The reliefs 126 are large enough to allow flow from exit through-passage 112 to pass through to cavity 131 and then passage 132 when reverse flow check is unseated from the margin of exit through-passage 112 and then becomes seated on ledge 129 which is provided by an annular zone of the surface of the proximal end face of proximal end wall 82 radially inward of a contiguous zone of that surface that abuts check valve body 44. Passage 132 runs parallel to axis AX from the center of cavity 131 to the distal end of sidewall 84 where it meets slant passage 76.

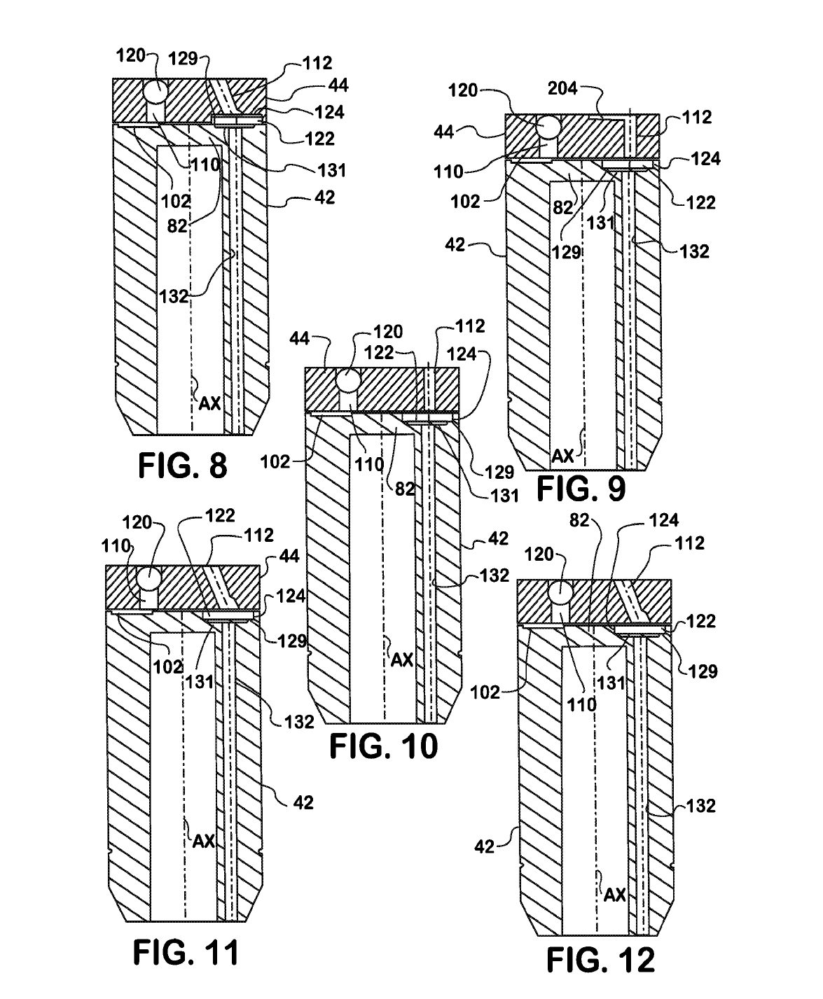

FIG. 9 shows a further embodiment of check valve body 44 and spring cage 42 that differs from the embodiment of FIG. 4 in that the axis of exit through-passage 112 is parallel to axis AX while still opening to exit cavity 104 at the center of the cavity. The proximal end face of check valve body 44 comprises a channel 204 through-which exit through-passage 112 communicates with zone 106 (FIG. 3), or with bore 47 in the absence of a zone 106 that is diametrically larger than bore portion 66.

FIG. 10 shows a further embodiment of check valve body 44 and spring cage 42 that is similar to the embodiment of FIG. 9 but differs in that it lacks channel 204 because zone 106 is wide enough to be open to exit through-passage 112 at the proximal end face of check valve body 44.

FIG. 11 shows a further embodiment of check valve body 44 and spring cage 42 that is similar to the embodiment of FIG. 4 but differs in that the axis of passage 132 is non-parallel to axis AX, with the passage opening at the distal end of sidewall 84 further radially outward than its opening at the proximal end face of proximal end wall 82. This is for meeting with an entrance of slant passage 76 that is further radially outward than in FIG. 1.

FIG. 12 shows a further embodiment of check valve body 44 and spring cage 42 that is similar to the embodiment of FIG. 4 but differs in that the axis of passage 132 is non-parallel to axis AX, opening at the distal end of sidewall 84 circumferentially offset from the opening at the proximal end face of proximal end wall 82 for meeting with an entrance of slant passage 76 that is circumferentially offset from its location in FIG. 1.

Features of the disclosed embodiments allow fuel injector 30 to inject fuel at higher pressures that can enhance the quality of combustion and engine performance.

What is claimed is:

1. A unit injector comprising:
a main body circumferentially surrounding an imaginary longitudinal axis and having an interior that is open both at a distal end and at a proximal end;
a fuel inlet port through which fuel can enter the interior of the main body;
a check valve body that is disposed within the interior of the main body and has a proximal end face and a distal end face;
an intensifier cartridge comprising a cartridge body that closes the open proximal end of the main body, that has a distal end face disposed within the interior of the main body against the proximal end face of the check valve body, and that has a bore extending proximally from a bore entrance at its distal end face;
a spring cage comprising an interior proximally bounded by a proximal end wall having a proximal end face and circumferentially bounded by a cylindrical sidewall, the proximal end face of the proximal end wall being disposed against the distal end face of the check valve body, and the sidewall of the spring cage extending distally from the proximal end wall of the spring cage to a distal end at which the interior of the spring cage is open;
a nozzle closing the open distal end of the main body and comprising a proximal end face disposed within the interior of the main body against the distal end of the spring cage sidewall;
the nozzle further comprising a needle guide bore comprising a proximal portion extending distally from the nozzle's proximal end face to a needle feed cavity and a distal portion extending distally from the needle feed cavity;
a bias spring housed within the interior of the spring cage;
a needle that is guided for axial displacement by the needle guide bore and that is biased by the bias spring against a seat in the distal portion of the needle guide bore to close a high-pressure injection path to orifices through which fuel is injected from the nozzle when the needle is unseated from the seat;
the check valve body comprising an entry through-passage open to the fuel inlet port and containing an entry check for opening and closing the entry through-passage to the bore entrance of the cartridge body;
the spring cage and the check valve body cooperatively defining a reverse flow check cavity between the proximal end face of the proximal end wall of the spring cage and the distal end face of the check valve body;
the check valve body comprising an exit through-passage for communicating the bore entrance of the cartridge body to the reverse flow check cavity;
a reverse flow check disposed in the reverse flow check cavity;
the spring cage comprising an adjoining cavity distally adjoining the reverse flow check cavity via a ledge on which the reverse flow check can seat, and a passage extending from the adjoining cavity to the distal end of the spring cage sidewall;
the nozzle comprising a passage extending from the nozzle's proximal end face to the needle feed cavity for communicating the passage in the spring cage to the needle feed cavity;
the intensifier cartridge comprising a plunger that is displaceable within the cartridge body bore along the longitudinal axis;
the plunger, when displaced axially proximally, being effective to unseat the entry check and allow fuel to pass through the fuel inlet port into the interior of the fuel injector, through the entry through-passage and the bore entrance into the cartridge body bore while forcing the reverse flow check to substantially close the exit through-passage;
and the plunger, when displaced axially distally, being effective to force the entry check to close the entry through-passage and force the reverse flow check out of substantial closure of the exit through-passage and to seat on the ledge, and to force fuel out of the cartridge body bore through the bore entrance and through the high-pressure injection path comprising the exit through-passage, the reverse flow check cavity, clearance between the reverse flow check and the ledge, the adjoining cavity, the passage in the spring cage, the passage in the nozzle, and the distal portion of the needle guide bore to cause the needle to unseat and fuel to be injected out of the nozzle through the orifices.

2. A unit injector as set forth in claim 1 in which the reverse flow check cavity has a central axis parallel to and spaced radially of the longitudinal axis, and the exit through-passage opens to the reverse flow check cavity substantially at the central axis.

3. A unit injector as set forth in claim 2 in which the reverse flow check cavity is in the distal end face of the check valve body and the ledge is a surface portion of the proximal end face of the proximal end wall of the spring cage.

4. A unit injector as set forth in claim 2 in which the reverse flow check cavity is in the proximal end face of the proximal end wall of the spring cage.

5. A unit injector as set forth in claim 2 in which the exit through-passage is straight and non-parallel to the longitudinal axis.

6. A unit injector as set forth in claim 2 in which the exit through-passage is straight and parallel to the longitudinal axis.

7. A unit injector as set forth in claim 6 further comprising a radial channel in the proximal end face of the check valve body through which the exit through-passage communicates with the bore entrance.

8. A unit injector as set forth in claim 1 in which the distal end face of the cartridge body comprises an entrance cavity through which the entry through-passage and the exit through-passage communicate with the bore entrance.

9. A unit injector as set forth in claim 1 in which the passage in the spring cage is straight and parallel to the longitudinal axis.

10. A unit injector as set forth in claim 1 in which the passage in the spring cage comprises a first portion extending from the adjoining cavity non-parallel with the longitudinal axis and a second portion that continues from the first portion and is straight and parallel to the longitudinal axis.

11. A unit injector as set forth in claim 1 in which the passage in the spring cage is straight and has an axis that is non-parallel to the longitudinal axis.

12. A unit injector as set forth in claim 1 in which the spring cage comprises a rounded undercut blending a surface of the spring cage sidewall on the spring cage interior and a surface of the spring cage proximal end wall on the spring cage interior.

13. A unit injector as set forth in claim 12 in which the rounded undercut extends radially outwardly from the surface of the spring cage sidewall on the spring cage interior before blending with the surface of the spring cage proximal end wall on the spring cage interior.

14. A unit injector as set forth in claim 12 in which the rounded undercut extends axially proximally of the surface of the spring cage sidewall on the spring cage interior beyond the surface of the spring cage proximal end wall before blending with the latter surface.

15. A unit injector as set forth in claim 12 in which the rounded undercut extends radially outwardly from the surface of the spring cage sidewall on the spring cage interior and then axially proximally beyond the surface of the spring cage proximal end wall on the interior of the spring cage before blending with the latter surface.

16. A unit injector having a longitudinal axis and comprising:
a nozzle having orifices through which fuel is injected from the nozzle;
a spring cage having an interior proximally bounded by a proximal end wall having a proximal end face and circumferentially bounded by a cylindrical sidewall that extends distally from the proximal end wall to a distal end at which the interior of the spring cage is open;
a bias spring disposed within the spring cage interior and biasing a needle to seat on a seat in the nozzle;
and a plunger operable on fuel in the injector to force open a reverse flow check disposed in a reverse flow check cavity in a high-pressure injection path from the plunger to the needle to unseat the needle from the seat against a seating force imposed on the needle by the bias spring and to force the fuel through the high-pressure injection path and out of the orifices;
the proximal end face of the proximal end wall of the spring cage comprising an adjoining cavity distally adjoining the reverse flow check cavity via a ledge on which the reverse flow check seats when forced open, and the high-pressure injection path comprises a passage extending from the adjoining cavity to the distal end of the spring cage sidewall.

17. A unit injector as set forth in claim 16 in which the passage in the spring cage is straight and parallel to a longitudinal axis along which the needle is unseated.

18. A unit injector as set forth in claim 16 in which the passage in the spring cage comprises a first portion from the adjoining cavity that is non-parallel to a longitudinal axis along which the needle is unseated and a second portion that continues from the first portion and is straight and parallel to the longitudinal axis.

19. A unit injector as set forth in claim 16 in which the passage in the spring cage is straight and has an axis that is non-parallel to the longitudinal axis.

20. A unit injector as set forth in claim 16 in which the spring cage comprises a rounded undercut blending an interior surface of a sidewall of the spring cage and an interior surface of the proximal end wall of the spring cage.

21. A unit injector as set forth in claim 20 in which the rounded undercut extends radially outwardly from the interior surface of the spring cage sidewall before blending with the interior surface of the proximal end wall of the spring cage.

22. A unit injector as set forth in claim 20 in which the rounded undercut extends axially proximally of the interior surface of a sidewall of the spring cage beyond the interior surface of the proximal end wall of the spring cage before blending with the latter surface.

23. A unit injector as set forth in claim 20 in which the rounded undercut extends radially outwardly from the interior surface of a sidewall of the spring cage and then axially proximally beyond the interior surface of the proximal end wall of the spring cage before blending with the latter surface.
